(19) United States
(12) Patent Application Publication
(10) Pub. No.: US 2014/0313555 A1
(43) Pub. Date: Oct. 23, 2014

(54) DIGITAL HOLOGRAM SYNTHESIS METHOD AND APPARATUS

(71) Applicant: Electronics and Telecommunications Research Institute, Daejeon (KR)

(72) Inventors: Seung Taik OH, Daejeon (KR); Ho Yong SEO, Seoul (KR); Wook Ho SON, Daejeon (KR)

(73) Assignee: Electronics and Telecommunications Research Institute, Daejeon (KR)

(21) Appl. No.: 14/222,059

(22) Filed: Mar. 21, 2014

(30) Foreign Application Priority Data
Apr. 22, 2013 (KR) 10-2013-0044254

(51) Int. Cl. G03H 1/08

(52) U.S. Cl. CPC G03H 1/0866
USPC 359/9

(57) ABSTRACT

Provided are a digital hologram synthesis method and apparatus based on an angular spectrum. The digital hologram synthesis method includes representing an input digital hologram as at least one angular spectrum region by applying Fourier transformation to the input digital hologram, registering the at least one angular spectrum region by projecting the at least one angular spectrum region onto a spherical surface, and generating a synthesis digital hologram based on the registered at least one angular spectrum region. Accordingly, it is possible to generate a new digital hologram with a different orientation or at a different distance using an angular spectrum of a digital hologram generated in advance, without geometric information of an object. In addition, it is possible to readily and intuitively synthesize a new digital hologram while viewing an image visualized in a 3D space.

### CLAIM FOR PRIORITY

This application claims priority to and benefit of Korean Patent Application No. 10-2013-0044254 filed on Apr. 22, 2013 in the Korean Intellectual Property Office (KIPO), the entire contents of which are hereby incorporated by reference.

### BACKGROUND

1. Technical Field

Example embodiments of the present invention relate in general to a digital hologram, and more specifically, to a digital hologram synthesis method and apparatus based on an angular spectrum.

2. Related Art

As next-generation image display technologies that can replace an existing image display apparatus, multi-view display technologies focusing on stereopsis, and ultra-high definition (UHD) display technologies focusing on an increase in realism and immersion due to an increase in screen resolution, have been actively discussed.

In particular, with regard to the multi-view display technologies, many technologies for reproducing three-dimensional (3D) images have been recently studied, but stereoscopic 3D technology that has been commercially available as representative 3D technology has technical limitations in that it requires wearing special glasses when viewing or it causes various inconveniences to users such as eye fatigue.

Thus, in order to implement complete 3D images which people ultimately desire, interest in holography technologies that can make natural image representation possible without restrictions on viewing positions has been growing.

The holography technologies may acquire an optical wave field including phase information as well as amplitude information of light with respect to an object so as to provide complete 3D images to viewers.

However, in a holographic display, it is difficult to secure a sufficient viewing angle due to limited resolution of a device for displaying digital images.

In typical photography, it is impossible to synthesize pictures obtained by changing view or focus in one picture, but a hologram includes 3D information of an object and therefore appearances of an object at different angles and scenes whose focus positions are different may be easily obtained in the existing hologram.

However, research into technology for synthesizing a new hologram at different angles from the existing hologram have been actively conducted, but there has been no remarkable outcome.

In the conventional art, research has been conducted into a method of generating a hologram with respect to a triangle that is inclined and scaled from a hologram with respect to a basic triangle by performing Fresnel transformation.

Such a method has been proposed for the purpose of rapidly generating a hologram of an object represented by mesh but uses the Fresnel transformation, and therefore it typically cannot provide correct results when the triangle is inclined.

In addition, as other technologies according to the prior art, a method of calculating shifted and rotated object waves using distribution of light in a frequency domain has been proposed. When using such a method, a new hologram at a rotated angle may be calculated from an existing hologram. However, the rotated angle is quite small due to restrictions on the digital hologram, and therefore an angle within which a new hologram can be created is quite limited.

### SUMMARY

Accordingly, example embodiments of the present invention are provided to substantially obviate one or more problems due to limitations and disadvantages of the related art.

Example embodiments of the present invention provide a method of synthesizing a hologram in a new orientation or position from an existing digital hologram.

Example embodiments of the present invention also provide an apparatus for synthesizing a hologram in a new orientation or position from an existing digital hologram.

Example embodiments of the present invention also provide an apparatus for providing a user interface that is visualized so as to synthesize a new digital hologram in a three-dimensional (3D) coordinate system.

In some example embodiments, a digital hologram synthesis method includes: representing an input digital hologram as at least one angular spectrum region by applying Fourier transformation to the input digital hologram; registering the at least one angular spectrum region by projecting the at least one angular spectrum region onto a spherical surface; and generating a synthesis digital hologram based on the registered at least one angular spectrum region.

Here, the representing of the input digital hologram may include representing the input digital hologram as rectangular shapes having different orientations, using a center of an object represented by the input digital hologram as a center of the at least one angular spectrum region.

Also, the registering of the at least one angular spectrum region may include visualizing the at least one angular spectrum region that each have a different orientation by projecting the at least one angular spectrum region in a normal direction of the spherical surface.

Also, the generating of the synthesis digital hologram may include generating a synthesis angular spectrum region based on the registered at least one angular spectrum region, and generating the synthesis digital hologram by performing inverse Fourier transformation on the synthesis angular spectrum region.

Also, the generating of the synthesis digital hologram may include reproducing a synthesis hologram reproduction image by numerical reconstruction of the synthesis digital hologram.

Also, the generating of the synthesis digital hologram may include setting a position or orientation in which the synthesis angular spectrum region is generated with reference to the synthesis hologram reproduction image.

In other example embodiments, a digital hologram synthesis apparatus includes: a registration unit configured to represent an input digital hologram as at least one angular spectrum region by applying Fourier transformation to the input digital hologram, and register the at least one angular spectrum region; and a synthesis unit configured to generate a synthesis digital hologram based on the registered at least one angular spectrum region.

Here, the registration unit may represent the input digital hologram as rectangular shapes having different orientations, using a center of an object represented by the input digital hologram as a center of the at least one angular spectrum region.

Also, the registration unit may visualize the at least one angular spectrum region that each have a different orientation by projecting the at least one angular spectrum region in a normal direction of a spherical surface.

Also, the synthesis unit may generate a synthesis angular spectrum region based on the registered at least one angular spectrum region, and generate the synthesis digital hologram by performing inverse Fourier transformation on the synthesis angular spectrum region.

Also, the digital hologram synthesis apparatus may further include a reproduction unit configured to reproduce a synthesis hologram reproduction image by numerical reconstruction of the synthesis digital hologram.

Also, the synthesis unit may set a position or orientation in which the synthesis angular spectrum region is generated with reference to the synthesis hologram reproduction image.

Also, the digital hologram synthesis apparatus may further include a display unit configured to visualize at least one of the at least one angular spectrum region, the synthesis angular spectrum region, the synthesis digital hologram, and the synthesis hologram reproduction image, in a 3D coordinate system.

In still other example embodiments, a digital hologram synthesis apparatus that provides a user interface includes: a first display region configured to visualize a synthesis angular spectrum region generated at a center of an object based on at least one angular spectrum region registered in advance; a second display region configured to convert the synthesis angular spectrum region visualized in the first display region into a position of a synthesis hologram to visualize the conversion result; and a third display region configured to visualize a synthesis digital hologram generated by performing inverse Fourier transformation on the synthesis angular spectrum region visualized in the second display region.

Here, the digital hologram synthesis apparatus may further include a fourth display region configured to visualize a synthesis hologram reproduction image reproduced by numerical reconstruction of the synthesis digital hologram.

Also, the digital hologram synthesis apparatus may further include a fifth display region configured to visualize at least one of the at least one angular spectrum region registered in advance, the synthesis angular spectrum region, the synthesis digital hologram, and the synthesis hologram reproduction image, in a 3D coordinate system.

Also, the fifth display region may use the center of the object as a center of the 3D coordinate system.

Also, the fifth display region may visualize the at least one angular spectrum region registered in advance and the synthesis angular spectrum region by projecting the at least one angular spectrum region registered in advance and the synthesis angular spectrum region onto a spherical surface.

Also, the second display region may set a position or orientation in which the synthesis angular spectrum region is generated with reference to the synthesis hologram reproduction image.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating registration of a digital hologram according to an embodiment of the present invention;

FIG. 2 is a conceptual diagram illustrating synthesis of a digital hologram according to an embodiment of the present invention;

FIG. 3 is a conceptual diagram illustrating synthesis of a digital hologram according to another embodiment of the present invention;

FIG. 4 is a conceptual diagram illustrating synthesis of a digital hologram according to still another embodiment of the present invention;

FIG. 5 is a flowchart illustrating a digital hologram synthesis method according to an embodiment of the present invention;

FIG. 6 is a block diagram illustrating a configuration of a digital hologram synthesis apparatus according to an embodiment of the present invention; and

FIG. 7 is a view illustrating an example of a user interface provided by a digital hologram synthesis apparatus according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, some terms used in the present application will be briefly described as follows.

Hologram refers to technology that recognizes, as light waves, light that is reflected by an object and enters the eyes of a user and records all pieces of information about the light waves in the form of interference fringes of light.

That is, when a hologram is illuminated, original light waves are restored through diffraction of the light, and when the restored light waves are observed, they create the illusion of a three-dimensional (3D) object.

In existing analog holography, a hologram with respect to still or slowly moving objects may be acquired and at the same time recorded on a special medium.

With the development of digital technologies, technologies for acquiring a hologram using the digital technologies, generating and compressing the hologram, transmitting the hologram and reproducing 3D images through the transmission are collectively referred to as digital holography technology. In particular, holographic display means reproducing 3D images from an acquired and generated hologram.

A digital hologram may be generated in such a manner that light waves are recorded directly on a charge coupled device (CCD) or the light waves are recorded on a pixel array in a digital form by computer-simulation of the light waves.

The digital hologram may be generally configured as a pixel array with a specific size. In this instance, a size of the pixel array may greatly affect a viewing angle of the digital hologram. A diffraction angle may be increased along with a reduction in the pixel size, and therefore a viewing angle at which an image reproduced by the hologram can be viewed may be increased.

However, with the current technology, it is impossible to sufficiently reduce the pixel size, and therefore a viewing angle supported by the digital hologram may be limited, unlike an analog hologram. For example, a digital hologram reproduction display that is currently widely used is a display with a pixel size of about 8 micrometers in full HD (1920×1080) resolution. In this case, a viewing angle of a reproduced hologram image is 5 degrees or less.

A computer generated hologram (CGH) is a digital hologram created by performing numerical simulation on diffraction and interference phenomenon of light, and may be created by recording object waves as complex numbers having both magnitude and sizes.

A spherical wave is a light wave propagating from a single point in space and has a spherical wavefront, and a plane wave is a special spherical wave with the source at infinity and has a planar wavefront.

The angular spectrum refers to the Fourier coefficients in the Fourier series representation of light wave, and may be acquired by performing Fourier transformation on a light wave.

Hereinafter, preferred embodiments of the present invention will be described in detail with reference to the accompanying drawings.

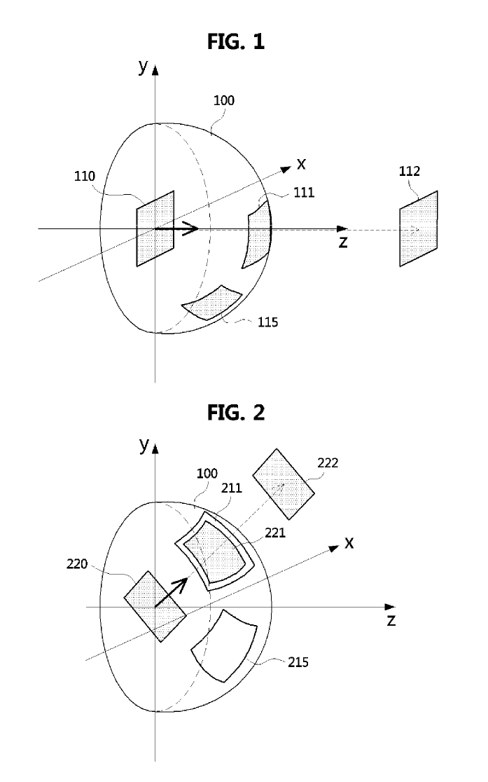

FIG. 1 is a conceptual diagram illustrating registration of a digital hologram according to an embodiment of the present invention.

Referring to FIG. 1, a process in which an input digital hologram is registered in the form of an angular spectrum to expand an angular spectrum region 110 of object waves will be described. In the present invention, a digital hologram may refer to a CGH.

By applying Fourier transformation to the input digital hologram, the input digital hologram may be represented as the angular spectrum region 110.

That is, the input digital hologram may be represented as rectangular shapes having different orientations, using a center of an object to be represented as a center of the angular spectrum region 110.

Here, the angular spectrum region 110 may refer to a region obtained in such a manner that amplitude or phase of object waves are represented as gray levels by applying Fourier transformation to the digital hologram.

An x-, y-, and z-axis indicate a 3D world coordinate system. Here, the origin of the coordinate system is used as the center of the object, and a direction of the z-axis is used as the direction of propagation of light.

In addition, a hemisphere 100 may be a space in which the angular spectrum region 110 of object waves which are calculated at the center of the object can be visualized and edited.

The angular spectrum region 110 that is determined by information (pixel size, the number of pixels) about an actual size of a hologram and a light wavelength may be represented as a rectangular 2D grid with respect to the origin of the coordinate system in a 2D region.

Accordingly, the angular spectrum region 110 obtained by performing Fourier transformation in an original position of the hologram may be propagated by a distance between the object and the hologram, thereby obtaining the information acquired at the center of the object.

A size of the 2D grid may be determined by a maximum value for each of an x-axis and a y-axis of the angular spectrum region 110, and may be 1.0/(2×pixel size of hologram) by a sampling theorem. In addition, an interval of the 2D grid may be determined as 1.0/(size of hologram). Here, a z-axis may be the direction of propagation of light.

In addition, the angular spectrum region 110 of a rectangular grid may be visualized by projecting the angular spectrum region 110 onto a spherical surface. That is, an angular spectrum region 111 visualized on the spherical surface 100 may be represented.

Accordingly, at least one angular spectrum region 110, each having a different orientation, may be registered on the spherical surface 100. For example, the at least one angular spectrum region that each have a different orientation may be projected onto the spherical surface 100 in a normal direction to be visualized.

The angular spectrum region 110 with respect to the input digital hologram may be visualized in the form of rectangle 112 in a 3D space, and a size of the rectangle may be proportional to an actual size (the number of pixels×pixel size) of a hologram.

Two important elements for calculating a position and an orientation of the angular spectrum region 110 are a local coordinate system of a hologram and a distance between the hologram and an object. Here, the local coordinate system of the hologram may be basic information provided by the hologram, and the distance between the hologram and the object may be input directly by a user if known or output through appropriate calculation.

In FIG. 1, an example in which the angular spectrum regions 111 and 115 having different orientations are projected onto a spherical surface is shown, but expansion of the angular spectrum region to the entire spherical surface is possible by projecting many more angular spectrum regions 110 that each have a different orientation onto the spherical surface.

Accordingly, the regions 111 and 115 which are projected onto the spherical surface 100 may be expanded through a process of registering the angular spectrum region 110 obtained by applying Fourier transformation to the input digital hologram, and a digital hologram with a new orientation or corresponding to a new viewpoint may be synthesized using the expanded angular spectrum region.

FIG. 2 is a conceptual diagram illustrating synthesis of a digital hologram according to an embodiment of the present invention.

Referring to FIG. 2, synthesis of the digital hologram will be described.

In FIG. 2, two regions 211 and 215 in which an angular spectrum region in accordance with a digital hologram registered in advance is projected onto a spherical surface 100 are shown, and a synthesis angular spectrum region 220 generated based on the registered angular spectrum region and a region 221 in which the synthesis angular spectrum region 220 is projected onto the spherical surface 100 are shown.

In addition, the synthesis angular spectrum region 220 may be visualized in the form of a rectangle 222 in a 3D space in a position of a synthesis hologram. Here, the position of the synthesis hologram may refer to a position in which the synthesis angular spectrum region 220 is projected onto the spherical surface 100.

Referring to FIG. 2, the digital hologram may be received to register a large number of angular spectrum regions in advance.

In addition, the registered angular spectrum regions 110 may be projected onto the spherical surface 100 to be visualized. That is, through the regions 211 and 215 in which the registered angular spectrum regions 110 are projected onto the spherical surface 100, expansion of the angular spectrum region may be understood.

Accordingly, by registering a large number of angular spectrum regions, the entire region on the spherical surface 100 can be covered. However, according to an embodiment of the present invention, the present invention is not limited only to a case in which the entire region on the spherical surface 100 is covered by the large number of angular spectrum regions. According to an embodiment of the present invention, a synthesis digital hologram may be generated based on the registered angular spectrum regions.

Specifically, a synthesis angular spectrum region 220 may be generated based on the registered angular spectrum regions 110, and the synthesis digital hologram may be generated by performing inverse Fourier transformation on the synthesis angular spectrum region 220.

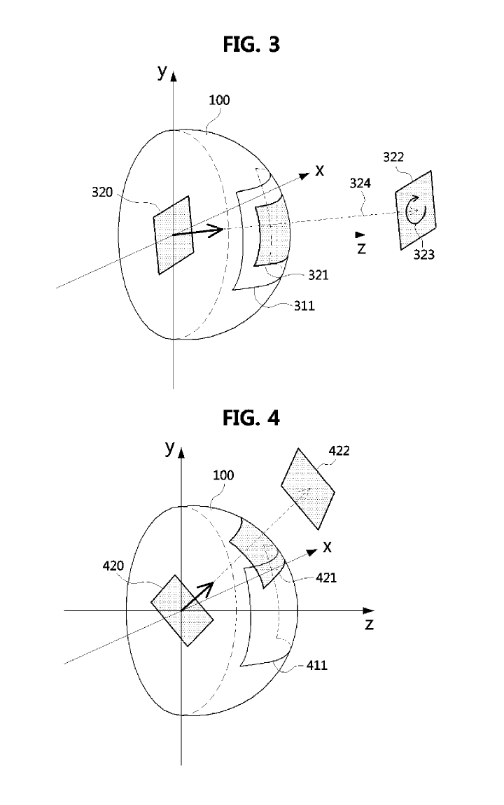

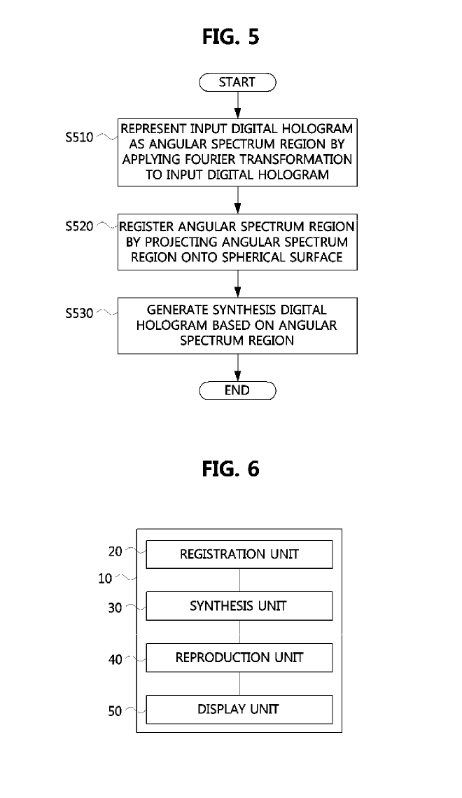

FIG. 3 is a conceptual diagram illustrating synthesis of a digital hologram according to another embodiment of the present invention, and FIG. 4 is a conceptual diagram illustrating synthesis of a digital hologram according to still another embodiment of the present invention.

Referring to FIGS. 3 and 4, a method in which a hologram is registered and then a new hologram is synthesized will be described.

First, in FIG. 3, a region 311 in which an angular spectrum region registered in advance in accordance with an input digital hologram is projected onto the spherical surface 100 is shown, and a synthesis angular spectrum region 320 generated based on the registered angular spectrum region and a region 321 in which the synthesis angular spectrum region 320 is projected onto the spherical surface 100 are shown.

In addition, the synthesis angular spectrum region 320 may be visualized in the form of a rectangle 322 in a 3D space at a position of a synthesis hologram. Here, the position of the synthesis hologram may refer to a position at which the synthesis angular spectrum region 320 is projected onto the spherical surface 100.

Referring to FIG. 3, it can be seen that a region 311 in which the angular spectrum region registered in advance is projected onto the spherical surface 100 includes a region 321 in which the synthesis angular spectrum region 320 is projected onto the spherical surface 100.

Accordingly, the synthesis angular spectrum region 320 may be generated using the angular spectrum region registered in advance.

Meanwhile, in order to calculate the synthesis angular spectrum region 320 based on the synthesis angular spectrum region 321 projected onto the spherical surface 100, an angular spectrum value in the synthesis angular spectrum region 321 projected onto the spherical surface has to be determined. In this case, an interpolation scheme may be utilized.

For example, the interpolation scheme to which a Gaussian kernel-based weighted value is applied may be utilized.

However, when the synthesis angular spectrum region 321 projected onto the spherical surface 100 is not completely included in the region 311 in which the angular spectrum region registered in advance is projected onto the spherical surface 100, a hologram may be synthesized using angular spectrum information that is partially lost.

In addition, the synthesis angular spectrum region 320 may be visualized in a 3D coordinate system, and an orientation and a position of the synthesis hologram may be adjusted based on the region 322 in which the synthesis angular spectrum region 320 is visualized in the 3D coordinate system.

In FIG. 3, the orientation of the synthesis hologram may be represented by a circular arrow 323, and the position of the synthesis hologram may be represented by a distance arrow 324.

The distance arrow 324 may be a normal vector passing through the center of the region 322 in which the synthesis angular spectrum region 320 is visualized in the 3D coordinate system. For example, obviously, the position of the synthesis hologram may be represented by a bold arrow shown at the center of the spherical surface 110 and numbers indicating the distance.

Accordingly, a user may adjust the orientation and distance of the synthesis digital hologram based on the circular arrow 323 and the distance arrow 324.

Next, in FIG. 4, a region 411 in which an angular spectrum region registered in advance in accordance with an input digital hologram is projected onto a spherical surface is shown, and a synthesis angular spectrum region 420 generated based on the registered angular spectrum region and a region in which the synthesis angular spectrum region 420 is projected onto the spherical surface are shown. In addition, the synthesis angular spectrum region 420 may be visualized in the form of a rectangle 422 in a 3D coordinate system.

Referring to FIG. 4, it can be seen that the region 411 in which the angular spectrum region registered in advance is projected onto the spherical surface does not completely include a region 421 in which the synthesis angular spectrum region 420 is projected onto the spherical surface 100. In this case, a hologram may be synthesized using angular spectrum information that is partially lost.

FIG. 5 is a flowchart illustrating a digital hologram synthesis method according to an embodiment of the present invention.

Referring to FIG. 5, the digital hologram synthesis method according to an embodiment of the present invention includes step S510 of representing a digital hologram as an angular spectrum region by applying Fourier transformation to the digital hologram, step S520 of registering the angular spectrum region, and step S530 of generating a synthesis digital hologram based on the angular spectrum region.

The digital hologram synthesis method according to an embodiment of the present invention may be performed by a digital hologram synthesis apparatus 10 which will be described later.

In step S510, the digital hologram synthesis method may represent an input digital hologram as at least one angular spectrum region 110 by applying Fourier transformation to the input digital hologram.

Specifically, the at least one angular spectrum region 110 may be represented as the rectangular shapes having different orientations, using the center of the object represented by the input digital hologram as the center of the at least one angular spectrum region.

In addition, the at least one angular spectrum region 121 that each have a different orientation may be projected in a normal direction of the spherical surface 100 to be visualized.

In step S520, the digital hologram synthesis method may register the at least one angular spectrum region 110 by projecting the at least one angular spectrum region 110 onto the spherical surface 100. This way, the at least one angular spectrum region 110 may be projected onto all or part of the spherical surface 100.

In step S530, the digital hologram synthesis method may generate a synthesis digital hologram based on the registered at least one angular spectrum region 110.

Specifically, the digital hologram synthesis method may generate the synthesis angular spectrum regions 220, 320, and 420 based on the registered at least one angular spectrum region 110, and generate the synthesis digital hologram by performing inverse Fourier transformation on the synthesis angular spectrum regions 220, 320, and 420.

In addition, the digital hologram synthesis method may reproduce a synthesis hologram reproduction image by numerical reconstruction of the synthesis digital hologram, and set positions or orientations in which the synthesis angular spectrum regions 220, 320, and 420 are generated with reference to the synthesis hologram reproduction image.

FIG. 6 is a block diagram illustrating a configuration of a digital hologram synthesis apparatus according to an embodiment of the present invention.

Referring to FIG. 6, a digital hologram synthesis apparatus 10 according to an embodiment of the present invention may include a registration unit 20, a synthesis unit 30, a reproduction unit 40, and a display unit 50.

The registration unit 20 may represent an input digital hologram as at least one angular spectrum region 110 by applying Fourier transformation to the input digital hologram, and may register the at least one angular spectrum region 110 by projecting the at least one angular spectrum region 110 onto a spherical surface.

The registration unit 20 may represent the input digital hologram as rectangular shapes having different orientations, using a center of an object represented by the input digital hologram as a center of the at least one angular spectrum region 110. That is, through this, the registered angular spectrum region 110 may be expanded.

In addition, the registration unit 20 may visualize the at least one angular spectrum region 110 that each have a different orientation by projecting the at least one angular spectrum region 110 in a normal direction of the spherical surface 100.

The synthesis unit 30 may generate a synthesis digital hologram based on the registered at least one angular spectrum region 110.

Specifically, the synthesis unit 30 may generate the synthesis angular spectrum regions 220, 320, and 420 based on the registered at least one angular spectrum region 110, and generate the synthesis digital hologram by performing inverse Fourier transformation on the synthesis angular spectrum regions 220, 320, and 420.

In addition, the synthesis unit 30 may set positions or orientations in which the synthesis angular spectrum regions 220, 320, and 420 are generated with reference to the synthesis hologram reproduction image.

Meanwhile, the reproduction unit 40 may reproduce a hologram reproduction image by numerical reconstruction of the synthesis digital hologram.

The display unit 50 may visualize at least one of the at least one angular spectrum region 110, the synthesis angular spectrum regions 220, 320, and 420, the synthesis digital hologram, and the synthesis hologram reproduction image, in a 3D coordinate system. For example, the display unit 50 may be implemented by a variety of display devices.

Components of the digital hologram synthesis apparatus 10 according to an embodiment of the present invention have been arranged and described above, but at least two of the components may be integrated into a single component, or a single component may be divided into a plurality of components to perform corresponding functions. Even cases in which each component is integrated or divided are included within the scope of the present invention.

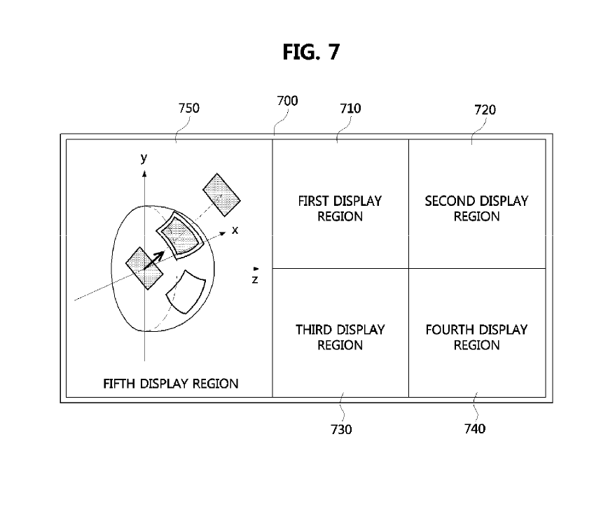

FIG. 7 is a view illustrating an example of a user interface provided by a digital hologram synthesis apparatus according to an embodiment of the present invention.

Referring to FIG. 7, the digital hologram synthesis apparatus 10 according to an embodiment of the present invention may provide a user interface 700 divided into at least one display region.

The user interface 700 according to an embodiment of the present invention may include five display regions. However, the present invention is not particularly limited to the number of the display regions, and the number of the display regions or characteristics thereof may be adaptively set as needed by a user.

A first display region 710 may visualize the synthesis angular spectrum regions 220, 320, and 420 which are generated at a center of an object, based on at least one angular spectrum region registered in advance.

A second display region 720 may convert the synthesis angular spectrum regions 220, 320, and 420 visualized in the first display region 710 into a position of a synthesis hologram to visualize the conversion result.

Here, the position of the synthesis hologram may refer to a position in which the synthesis angular spectrum regions 220, 320, and 420 visualized in the first display region 710 are projected onto the spherical surface 100.

In addition, the second display region 720 may set positions or orientations in which the synthesis angular spectrum regions 220, 320, and 420 are generated with reference to a synthesis hologram reproduction image.

A third display region 730 may visualize a synthesis digital hologram generated by performing inverse Fourier transformation on the synthesis angular spectrum regions 220, 320, and 420 visualized in the second display region 720.

A fourth display region 740 may visualize a synthesis hologram reproduction image reproduced by numerical reconstruction of the synthesis digital hologram.

A fifth display region 750 may visualize at least one of the at least one angular spectrum region registered in advance, the synthesis angular spectrum regions 220, 320, and 420, the synthesis digital hologram, and the synthesis hologram reproduction image, in a 3D coordinate system.

In addition, the fifth display region 750 may use the center of the object represented by the input digital hologram as a center of the 3D coordinate system, and visualize the at least one angular spectrum region registered in advance and the synthesis angular spectrum regions 220, 320, and 420 by projecting the at least one angular spectrum region registered in advance and the synthesis angular spectrum regions 220, 320, and 420 onto the spherical surface 100.

The respective display regions according to the embodiments of the present invention may be operated in conjunction with each other. For example, when a user edits a digital hologram using a single display region, the editing result may be visualized from mutually different viewpoints and the visualized results may be provided to the user.

Thus, the user may edit the angular spectrum region and the hologram using the display regions visualized in a 2D or 3D manner.

For example, the digital hologram synthesis apparatus 10 according to the embodiments of the present invention may provide image editing functions such as cut, copy, paste, or noise removal, and the like on each of the display regions, and the edited image (hologram) may be visualized in real-time and provided to a user.

In addition, operations of the digital hologram synthesis apparatus 10 according to embodiments of the present invention may be implemented as a computer-readable program or code in a computer-readable recording medium.

The computer-readable recording medium includes all types of recording devices in which data that can be read by a computer system can be stored. In addition, the computer-readable recording medium may be distributed among computer systems connected via a network, so that the computer-readable program or code may be stored and executed in a decentralized fashion.

As described above, according to the embodiments of the present invention, the digital hologram synthesis apparatus and method may synthesize, from a large number of holograms, a new hologram obtained at an arbitrary angle and position without geometric information of an object that is recorded in the hologram.

In addition, the user interface that enables each spectrum to be edited on a 3D space may be provided, thereby providing an intuitive and convenient hologram editing method.

The digital hologram synthesis method and apparatus according to the embodiments of the present invention can generate new digital holograms with different orientations or at different distances using spectra of a digital hologram generated in advance, without geometric information of an object.

In addition, the user interface that enables the digital hologram to be easily edited in a 3D space may be provided, whereby a user can intuitively and easily synthesize a new digital hologram while viewing an image visualized in the 3D coordinate system.

While the example embodiments of the present invention and their advantages have been described in detail, it should be understood that various changes, substitutions, and alterations may be made herein without departing from the scope of the invention.

What is claimed is:

1. A digital hologram synthesis method comprising:
representing an input digital hologram as at least one angular spectrum region by applying Fourier transformation to the input digital hologram;
registering the at least one angular spectrum region by projecting the at least one angular spectrum region onto a spherical surface; and
generating a synthesis digital hologram based on the registered at least one angular spectrum region.

2. The digital hologram synthesis method of claim 1, wherein the representing of the input digital hologram includes representing the input digital hologram as rectangular shapes having different orientations, using a center of an object represented by the input digital hologram as a center of the at least one angular spectrum region.

3. The digital hologram synthesis method of claim 1, wherein the registering of the at least one angular spectrum region includes visualizing the at least one angular spectrum region, which each have a different orientation, by projecting the at least one angular spectrum region in a normal direction of the spherical surface.

4. The digital hologram synthesis method of claim 1, wherein the generating of the synthesis digital hologram includes generating a synthesis angular spectrum region based on the registered at least one angular spectrum region, and generating the synthesis digital hologram by performing inverse Fourier transformation on the synthesis angular spectrum region.

5. The digital hologram synthesis method of claim 4, wherein the generating of the synthesis digital hologram includes reproducing a synthesis hologram reproduction image by numerical reconstruction of the synthesis digital hologram.

6. The digital hologram synthesis method of claim 5, wherein the generating of the synthesis digital hologram includes setting a position or orientation in which the synthesis angular spectrum region is generated with reference to the synthesis hologram reproduction image.

7. A digital hologram synthesis apparatus comprising:
a registration unit configured to represent an input digital hologram as at least one angular spectrum region by applying Fourier transformation to the input digital hologram, and register the at least one angular spectrum region; and
a synthesis unit configured to generate a synthesis digital hologram based on the registered at least one angular spectrum region.

8. The digital hologram synthesis apparatus of claim 7, wherein the registration unit represents the input digital hologram as rectangular shapes having different orientations, using a center of an object represented by the input digital hologram as a center of the at least one angular spectrum region.

9. The digital hologram synthesis apparatus of claim 7, wherein the registration unit visualizes the at least one angular spectrum region, which each have a different orientation, by projecting the at least one angular spectrum region in a normal direction of a spherical surface.

10. The digital hologram synthesis apparatus of claim 7, wherein the synthesis unit generates a synthesis angular spectrum region based on the registered at least one angular spectrum region, and generates the synthesis digital hologram by performing inverse Fourier transformation on the synthesis angular spectrum region.

11. The digital hologram synthesis apparatus of claim 10, further comprising:
a reproduction unit configured to reproduce a synthesis hologram reproduction image by numerical reconstruction of the synthesis digital hologram.

12. The digital hologram synthesis apparatus of claim 11, wherein the synthesis unit sets a position or orientation in which the synthesis angular spectrum region is generated with reference to the synthesis hologram reproduction image.

13. The digital hologram synthesis apparatus of claim 12, further comprising:
a display unit configured to visualize at least one of the at least one angular spectrum region, the synthesis angular spectrum region, the synthesis digital hologram, and the synthesis hologram reproduction image, in a 3D coordinate system.

14. A digital hologram synthesis apparatus that provides a user interface, the apparatus comprising:
a first display region configured to visualize a synthesis angular spectrum region generated at a center of an object based on at least one angular spectrum region registered in advance;
a second display region configured to convert the synthesis angular spectrum region visualized in the first display region into a position of a synthesis hologram to visualize the conversion result; and
a third display region configured to visualize a synthesis digital hologram generated by performing inverse Fourier transformation on the synthesis angular spectrum region visualized in the second display region.

15. The digital hologram synthesis apparatus of claim 14, further comprising:
a fourth display region configured to visualize a synthesis hologram reproduction image reproduced by numerical reconstruction of the synthesis digital hologram.

16. The digital hologram synthesis apparatus of claim 15, further comprising:
a fifth display region configured to visualize at least one of the at least one angular spectrum region registered in advance, the synthesis angular spectrum region, the synthesis digital hologram, and the synthesis hologram reproduction image, in a 3D coordinate system.

17. The digital hologram synthesis apparatus of claim 16, wherein the fifth display region uses the center of the object as a center of the 3D coordinate system.

18. The digital hologram synthesis apparatus of claim 16, wherein the fifth display region visualizes the at least one angular spectrum region registered in advance and the synthesis angular spectrum region by projecting the at least one angular spectrum region registered in advance and the synthesis angular spectrum region onto a spherical surface.

19. The digital hologram synthesis apparatus of claim 16, wherein the second display region sets a position or orientation in which the synthesis angular spectrum region is generated with reference to the synthesis hologram reproduction image.
